(19) United States
(12) Patent Application Publication
(10) Pub. No.: US 2012/0119570 A1
(43) Pub. Date: May 17, 2012

(54) HOUSING OR HOUSING PART FOR A CONTROL UNIT OF A MOTOR VEHICLE

(75) Inventors: Markus Haeberlin, Tamm (DE); Harrie van Oirsouw, Stuttgart (DE); Peter Leonard, Clarinda (AU); Kenan Dogan, Backnang (DE)

(73) Assignee: ROBERT BOSCH GMBH, Stuttgart (DE)

(21) Appl. No.: 13/321,475

(22) PCT Filed: Mar. 22, 2010
(86) PCT No.: PCT/EP10/53705

§ 371 Date: Jan. 26, 2012

(30) Foreign Application Priority Data
May 20, 2009 (DE) 102009003284.3

(51) Int. Cl. B60L 1/00

(52) U.S. Cl. 307/9.1

(57) ABSTRACT

The invention relates to a housing (10) or housing part (11) for a control device of a motor vehicle, having a surface structure (22) deviating at least partly from a flat plane, wherein the surface structure (22) comprises a plurality of planes (24, 26; 30, 32, 34) whose superficial dimensions are substantially equally large.

### BACKGROUND OF THE INVENTION

A known way of reinforcing load-bearing parts, housings or housing parts is to provide these with a honeycomb structure in conjunction with the lightest possible construction. DE 42 32 953 A1, for example, shows a production method for reinforcing vehicle bodies or other components susceptible to torsion, with the aim of reducing the specifically rigidity-related space taken up by additional body reinforcements, and of optimizing the rigidity-related weight increase. Use is made here of a sandwich structure, in which a flexible intermediate layer of very low specific weight, which keeps two outer, thin covering layers a distance apart, leads to a very rigid and moreover lightweight overall structure. JP 2007215328 and DE 10 2004 002 276 A1 show a comparable construction for vehicle bodies.

SU 1836811 A3 discloses the provision of a housing having a smooth and thin outer surface on the inside with a lightweight reinforcing frame, which has a honeycomb-like structure. Housings or housing parts having ribbed structures, which bring only an insignificant increase in weight but lead to a very high rigidity, are also known.

### SUMMARY OF THE INVENTION

Compared to the state of the art, the housing or housing part according to the invention for a control unit of a motor vehicle, having a surface structure deviating at least partially from a plane surface, affords the advantage that it achieves a very high rigidity and fracture resistance in conjunction with a saving in the housing volume and material by virtue of a relatively small wall thickness. For this purpose it is proposed that the surface structure be composed of multiple planes, the areas of which are substantially equal in size.

It is particularly advantageous if the individual planes of the surface structure have the same contours, which are of triangular, quadrilateral or hexagonal shape. The contours therefore join together without interstices, which further increases the fracture resistance and rigidity.

The torsional rigidity of the housing or housing part can moreover be improved if the surface structure is composed of at least three planes.

Material can furthermore be saved if the surfaces of the inside and outside of the housing or housing part are inverted relative to one another in the area of the surface structure, so that a completely smooth surface does not remain on any side. In addition or alternatively it is possible for the surface structure to extend over at least an entire side of the housing or housing part, except for areas for connections and identification marking areas.

If the individual planes are connected to one another in such a way that the wall thickness between the planes substantially corresponds to the wall thickness of the planes, it is advantageously possible to obtain a constant rigidity distribution in the area of the surface structure.

It is advantageously possible for electronic components of the control unit to be arranged in the area of the surface structure, in such a way that they utilize the overall space created by the various planes, so that the total volume of the housing is reduced overall. If the housing or the housing part is made of metal, its enlarged surface moreover allows it to be used as a cooling element in connection with electrical components generating a lot of heat, for example power transistors.

### BRIEF DESCRIPTION OF THE DRAWINGS

In the drawings

FIG. 1 shows a first exemplary embodiment of a housing according to the invention,

FIG. 2 shows a perspective sectional view of a second exemplary embodiment of a housing or housing part according to the invention,

FIG. 3 shows an enlarged detail of the perspective sectional view in FIG. 2, and

FIG. 4 shows a further exemplary embodiment of the housing or housing part according to the invention in a perspective sectional view.

### DETAILED DESCRIPTION

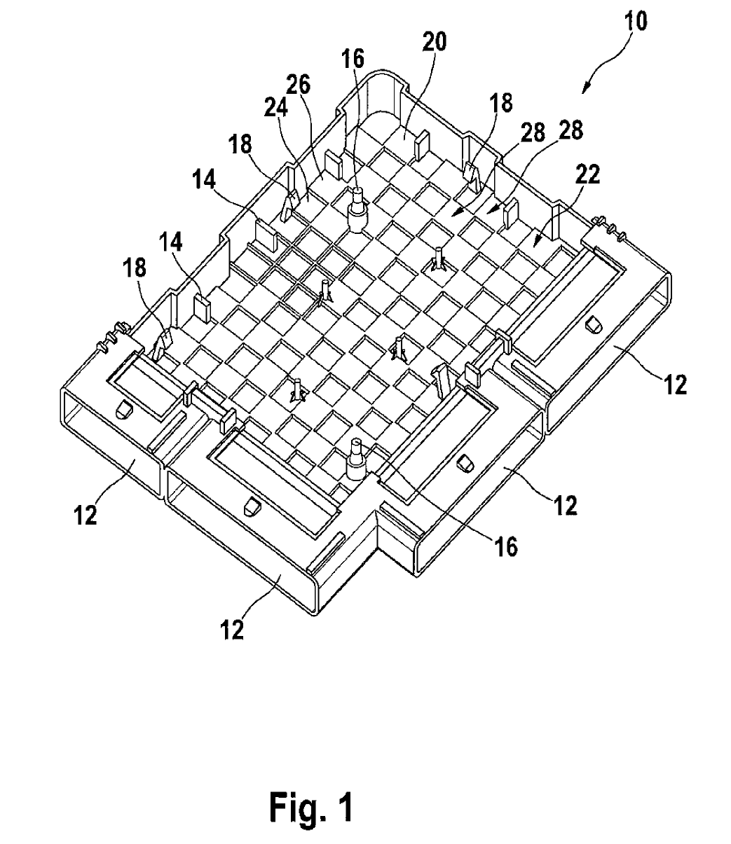

FIG. 1 shows a housing 10 of a control unit, not further represented, of a motor vehicle. The housing 10 has openings for connections 12 of the control unit, via which the control unit is connected by power and/or data connections to other units, not further specified. Webs 14, lugs 16 and fastening catches 18 for fixing a circuit board (not shown) of the control unit are also provided.

In order to reduce the housing volume and material and to increase the housing rigidity and the fracture resistance compared to housings with ribbed structures, the underside 20 of the housing 10 shown in FIG. 1 is provided throughout with a surface structure 22, which deviates from a plane surface in that it is composed of two planes 24 and 26, the areas of which are substantially equal in size. For this purpose, both planes 24 and 26 have identical contours 28 —in this case a plurality of quadrilaterals, the number of recessed quadrilaterals identifiable in the first plane 24 corresponding approximately to the number of raised quadrilaterals in the second plane 26 and the individual quadrilaterals of the two planes 24 and 26 being virtually equal in size.

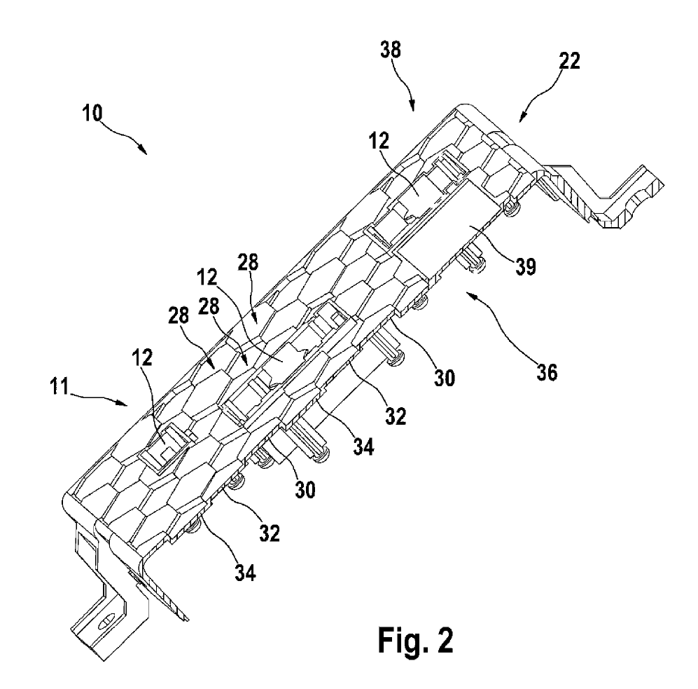

FIG. 2 shows a perspective sectional view of a further exemplary embodiment of an inventive housing part 11 of a housing 10 for a control unit of a motor vehicle. In contrast to FIG. 1, the surface structure 22 now comprises three planes 30, 32 and 34, the contours 28 of the three planes 30, 32 and 34 now being of hexagonal shape. It can again be seen that the areas of the three planes 30, 32 and 34 are virtually equal in size, since they do not differ substantially from one another in the number of hexagons and their areas.

The surfaces of the inside 36 and outside 38 of the housing part 1 are furthermore designed so that they are inverted in relation to one another in the area of the surface structure 22. In contrast, therefore, to a housing in which only the inside has a multi-level surface structure 22, whilst the outside is of completely plane design, for example, it is additionally possible to save material without the rigidity and fracture resistance suffering. In order to be able to provide the housing 10 according to the invention with type identification markings or other inscriptions, however, it is further proposed that the surface structure 22 should not extend over the area of identification marking surfaces 39 and electrical and/or mechanical connections 12.

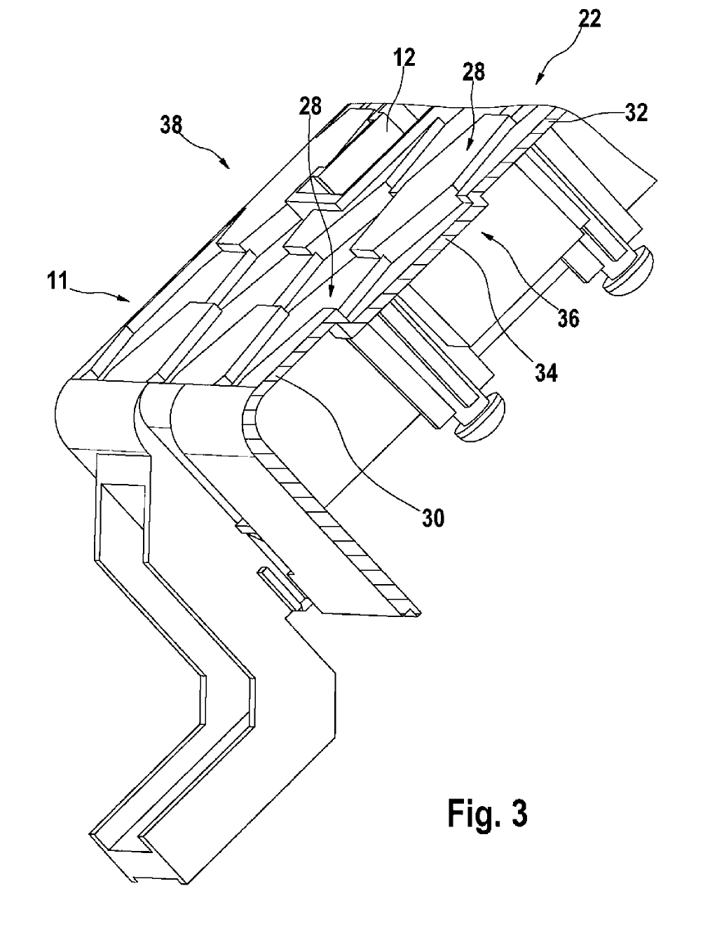

FIG. 3, by way of illustration, shows an enlarged detail of the perspective view of the housing part 11 in FIG. 2. The three different planes 30, 32 and 34 with their hexagonal contours 28 are clearly discernible. Also very clearly visible here is the inversion between the inside 36 and outside 38 in the area of the surface structure 22.

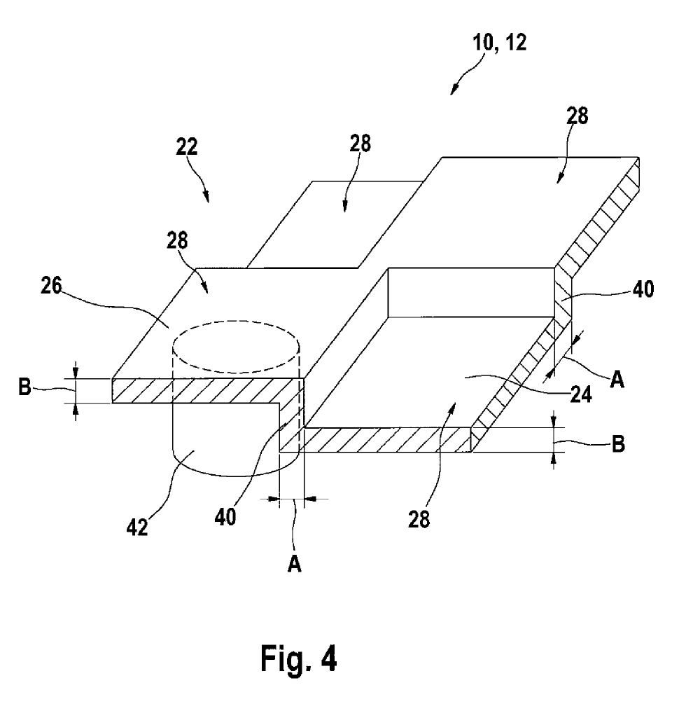

FIG. 4 shows a further perspective sectional view of the surface structure 22 of the housing 10 according to FIG. 1 for two planes 24 and 26 with quadrilateral contours 28. It will be clear from this that the wall thickness A of the webs 40 between the planes 24 and 26 is substantially equal to the wall thickness B of the planes 24, 26. This affords a high degree of homogeneous fracture resistance and rigidity of the housing 10 or housing part 11 in the area of the surface structure 22.

FIG. 4 also represents a component 42 of the control unit, for example a capacitor, which is arranged in the area of the surface structure 22 in such a way that it makes optimum use of the overall space afforded by the various planes 24 and 26. In this way it is possible to minimize the overall volume of the housing.

It should finally be pointed out that the exemplary embodiments shown are not limited to FIGS. 1 to 4. Thus, for example, in addition to quadrilateral and hexagonal contours of the individual planes, triangular contours may also be used. The number of planes is also not limited to a maximum of three. Plastics and/or metal may be used as material of the housing 10 or the housing part 11. With a metal housing, in particular, the enlarged surface affords an improved cooling effect.

1. A housing (10, 11) for a control unit of a motor vehicle, the housing (10, 11) having a surface structure (22) deviating at least partially from a plane surface, characterized in that the surface structure (22) is composed of multiple individual planes (24, 26; 30, 32, 34), areas of which are substantially equal in size.

2. The housing (10, 11) as claimed in claim 1, characterized in that the planes (24, 26; 30, 32, 34) of the surface structure (22) have the same contours (28).

3. The housing (10, 11) as claimed in claim 2, characterized in that the contours (28) of the individual planes (24, 26; 30, 32, 34) are each one of triangular, quadrilateral or hexagonal shape.

4. The housing (10, 11) as claimed in claim 1, characterized in that the surface structure (22) is composed of at least three planes (30, 32, 34).

5. The housing (10, 11) as claimed in claim 1, characterized in that surfaces of an inside (36) and outside (38) of the housing (10, 11) are inverted relative to one another in an area of the surface structure (22).

6. The housing (10, 11) as claimed in claim 1, characterized in that the surface structure (22) extends over at least an entire side (20) of the housing (10, 11) except for areas for connections (12) and identification marking surfaces (39).

7. The housing (10, 11) as claimed in claim 1, characterized in that the individual planes (24, 26; 30, 32, 34) are connected to one another in such a way that a wall thickness (A) between the planes (24, 26; 30, 32, 34) substantially corresponds to a wall thickness (B) of the planes (24, 26; 30, 32, 34).

8. The housing (10, 11) as claimed in claim 1, characterized in that components (40) of the control unit are arranged in an area of the surface structure (22) in such a way that the components (40) utilize an overall space created by the planes (24, 26; 30, 32, 34).
